(19) United States
(12) Patent Application Publication
(10) Pub. No.: US 2019/0370009 A1
(43) Pub. Date: Dec. 5, 2019

(54) INTELLIGENT SWAP FOR FATIGABLE STORAGE MEDIUMS

(71) Applicant: Apple Inc., Cupertino, CA (US)

(72) Inventors: Kartik R. Venkatraman, Santa Clara, CA (US); Abhishek Bhowmick, Santa Clara, CA (US); Lionel D. Desai, San Francisco, CA (US)

(21) Appl. No.: 16/399,513

(22) Filed: Apr. 30, 2019

Related U.S. Application Data
(60) Provisional application No. 62/679,844, filed on Jun. 3, 2018.

(51) Int. Cl. G06F 9/445; G06F 3/06; G06N 7/00

(52) U.S. Cl. CPC G06F 9/445; G06F 3/0604; G06N 7/005; G06F 3/0679; G06F 3/0653

(57) ABSTRACT

One embodiment provides for a method comprising determining a set of probabilities associated with a set of applications configured to execute on the electronic device, the set of probabilities including a probability of application usage within a period of time, updating a probability model based on the set of probabilities associated with the set of applications, selecting an application to swap to a fatigable storage device based on output from the probability model, and swapping the application to the fatigable storage device, wherein swapping the application includes storing a memory address space for the application and an application state to the fatigable storage device.

### CROSS-REFERENCE

This application claims priority to U.S. Provisional Patent Application No. 62/679,844 filed Jun. 3, 2018, which is hereby incorporated herein by reference.

### FIELD

Embodiments described herein relate to virtual memory systems, and more specifically, enabling intelligent swap for fatigable storage mediums.

### BACKGROUND OF THE DISCLOSURE

Virtualization techniques have been developed to enable computing devices to execute programs using a virtual memory space with a size exceeding the actual physical capacity of the memory on the device. This may particularly be of use on mobile and handheld devices that, due to physical size constraints, may have a reduced amount of process memory and data storage capacity relative to larger form factor devices. However, conventional virtual memory systems utilize memory swapping techniques in which unused regions of virtual memory may be swapped to a storage device coupled to the memory device to free regions of process memory. Conventionally, mobile and handheld devices have avoided the use of swap files or swap partitions due to the wear induced on the fatigable storage mediums (e.g., NAND flash) used by such devices. Frequent swapping of volatile memory to such storage devices can accelerate the wear and decline in functionality for such devices. Accordingly, manufacturers for mobile or handheld devices have pursued alternatives to the traditional virtual memory backing store.

### SUMMARY OF THE DESCRIPTION

One embodiment provides for a method comprising determining a set of probabilities associated with a set of applications configured to execute on an electronic device, updating a probability model based on the set of probabilities associated with the set of applications, the set of probabilities including a probability of application usage, selecting an application to swap to a fatigable storage device based on output from the probability model, and swapping the application to the fatigable storage device, wherein swapping the application includes storing data within a memory address space for the application and an application state.

One embodiment provides for an electronic device comprising a non-volatile electrically-erasable semiconductor memory device, a memory device coupled with the non-volatile electrically-erasable semiconductor memory device, and one or more processors to load instructions from the non-volatile electrically-erasable semiconductor memory device into the memory device and execute the instructions. The instructions, when executed, cause the one or more processors to determine a set of probabilities associated with a set of applications configured to execute on the electronic device, the set of probabilities including a probability of application usage, update a probability model based on the set of probabilities, receive a request to terminate a process of an application in the set of applications, the application having a virtual address space at least partially mapped to the memory device, query the probability model to determine whether memory of the application is to be swapped to the non-volatile electrically-erasable semiconductor memory device before the process is to be terminated, and store memory within the virtual address space of the application to the non-volatile electrically-erasable semiconductor memory device based on a result of the query.

One embodiment provides for a non-transitory machine-readable medium storing instructions to cause one or more processors of an electronic device to perform operations comprising determining a set of probabilities associated with a set of applications configured to execute on the electronic device, updating a probability model based on the set of probabilities associated with the set of applications, the set of probabilities including a probability of application usage, selecting an application to swap to a fatigable storage device based on output from the probability model, wherein the probability model includes a machine-learning model, and swapping the application to the fatigable storage device, wherein swapping the application includes storing data within a memory address space for the application and an application state.

The above summary does not include an exhaustive list of all aspects or embodiments of the present invention. It is contemplated that the embodiments of the invention include all systems and methods that can be practiced from all suitable combinations of the various aspects summarized above. Moreover, other features of the present invention will be apparent from the accompanying drawings, a brief description of which is provided below.

### BRIEF DESCRIPTION OF THE DRAWINGS

The present embodiments are illustrated by way of example, and not limitation, in the figures of the accompanying drawings in which like references indicate similar elements, and in which:

FIG. 1 is a block diagram of exemplary data processing system components including hardware to implement a virtual memory system, according to an embodiment;

FIG. 2 is a block diagram illustrating a data processing system including a compressed virtual memory system, according to an embodiment;

FIG. 3 is a block diagram illustrating swapping an application address space to a flash memory device, according to an embodiment;

FIG. 4 is a block diagram illustrating compression and compaction of virtual memory, according to an embodiment;

FIG. 5 is an illustration of an electronic device with support for simultaneous execution of multiple applications, according to an embodiment;

FIG. 6 is a flow diagram of logic for a memory usage manager, according to an embodiment;

FIG. 7A-7E illustrate time-slot based application swap probability calculation, according to embodiments;

FIG. 8 is a flow diagram illustrating logic for an intelligent swap determination by a memory usage manager, according to an embodiment;

FIG. 9 is a flow diagram illustrating logic to swap and restore application memory and application state from non-volatile virtual memory, according to an embodiment;

FIG. 10 is a block diagram of system software architecture for a multi-user data processing system, according to an embodiment;

FIG. 11 is a block diagram of a multi-layer software architecture used by a data processing system, according to an embodiment;

FIG. 12 is a block diagram of data processing system hardware according to an embodiment; and

FIG. 13 is a block diagram of an additional data processing system, according to an embodiment.

### DETAILED DESCRIPTION

Various embodiments and aspects of a virtual memory system for electronic devices in which swapping of virtual memory to non-volatile storage is enabled for fatigable storage devices such as NAND flash devices and/or other electrically erasable semiconductor memories. Wear to the storage devices is limited by the use of an intelligent swap manager that selects the most efficient applications to swap to non-volatile storage. The intelligent swap manager can gather application popularity statistics (launches, activations, etc.) during a time period and generate a set of probabilities that an application will be used within a given time period. Such probabilities can be used along with other device behavior data to generate a training set of a probability model. In one embodiment, the gathering of application usage statistics is performed only of the user of the system opts-in to the gathering of such statistics.

In one embodiment the probability can be used to generate a swap prediction vector in which each element includes a probability value that reflects a prediction that an application on the electronic device would be an efficient application to swap. Efficiency, in this context, indicates that swapping the application to storage would be an efficient use of a limited swap budget available to the memory management system on the electronic device. The probability model can be periodically updated with new data as application usage patterns change over time. The swap prediction data generated by the probability model can also take into account potential increases or decreases in a swap budget over time. In one embodiment, the probability model includes a machine learning model.

In one embodiment, when an application is selected to be swapped, a memory usage manager on the device can swap the application, application memory, and runtime state of the application to non-volatile memory instead of terminating the application. In one embodiment, the application memory can be compressed and compacted before being stored to the non-volatile storage device, to further reduce the wear on the device. When a selected application is to be reactivated, the compressed virtual memory that is stored to the non-volatile memory can be restored to system memory.

The present description includes material protected by copyrights, such as illustrations of graphical user interface images. The owners of the copyrights, including the assignee of the present invention, hereby reserve their rights, including copyright, in these materials. The copyright owner has no objection to the facsimile reproduction by anyone of the patent document or the patent disclosure, as it appears in the Patent and Trademark Office file or records, but otherwise reserves all copyrights whatsoever. Copyright Apple Inc. 2018.

References to “one embodiment” or “an embodiment” means that a particular feature, structure, or characteristic described in conjunction with the embodiment can be included in at least one embodiment of the invention. The appearances of the phrase “in one embodiment” in various places in the specification do not necessarily all refer to the same embodiment.

The following description is illustrative of various embodiments of the invention and is not to be construed as limiting. Numerous specific details are described to provide a thorough understanding of various embodiments of the present invention. However, in certain instances, well-known or conventional details are not described in order to provide a concise discussion of embodiments of the present invention.

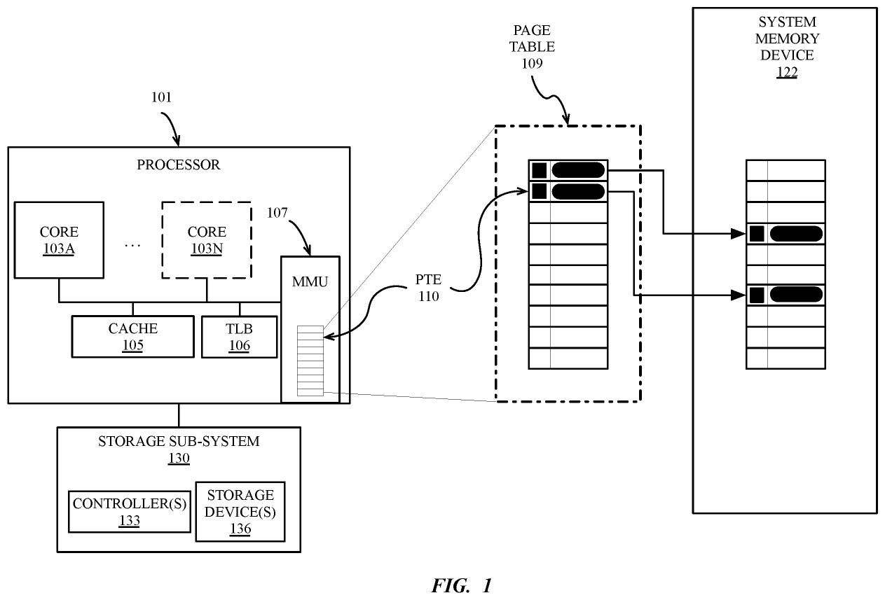

FIG. 1 is a block diagram of exemplary data processing system components including hardware to implement a virtual memory system, according to an embodiment. The exemplary system includes a processor 101 having one or more cores 103A-N, a cache 105, a memory management unit 107 (MMU), and a translation lookaside buffer (TLB) 106. The system further includes a physical system memory device 122 and a storage sub-system 130 including one or more controllers 133 coupled to one or more storage devices 136. The exemplary virtual memory system can be configured to present disjoint regions of the system physical memory device 122 as a contiguous virtual memory address space and can be included in a mobile or handheld data processing system.

The MMU 107 included in the processor can be configured to accelerate virtual memory to physical memory address translation in hardware. The MMU 107 can be configured with the address of one or more page tables 109 stored in the physical system memory device 122. Each page table 109 is a data structure that contains multiple page table entries (e.g., PTE 110), each PTE containing the physical address of a page of memory. The size of a memory page can vary based on system configuration and processor architecture. Each page table is indexed by the virtual address of the page of memory. Data from the page table 109 can be cached in the TLB 106 to further accelerate address translation.

The MMU 107 uses data in the TLB 106 or in the page table 109 in memory to translate a given input virtual address into an output physical address if a physical memory address exists in the physical system memory device 122 for the given virtual address. A virtual memory address contains several bits, the number of bits corresponding to the size of the virtual address space. A portion of the bits can correspond to a virtual page related to the memory address, and a portion of the bits can correspond to a memory offset within the page, depending on the virtual memory configuration of the system. A 64-bit virtual memory system can use up to 64 bits of address space, allowing over 18 exabytes of addressable space. Accordingly, the virtual memory system can enable an operating system of a computing device to address significantly more memory than physically included in the system.

In conventional virtual memory systems, as available space in the system physical memory device 122 is consumed, virtual memory pages on the memory device 122 may be backed up to the storage sub-system 130. However, some computing systems that are designed to exclusively use fatigable non-volatile storage, virtual memory pages on the memory device 122 may simply be removed from the system memory device 122 and discarded (e.g., in association with terminating any applications using the discarded virtual memory pages). The use of a non-volatile backing store in such systems may be omitted due to the limit on the number of writes that can be performed to such devices. For example, a NAND flash cell can sustain only a finite number of erase cycles before becoming unusable. As NAND flash cells within a flash storage device degrade, the storage capacity and performance of the storage device may be decreased.

In embodiments described herein, an intelligent swap system is provided to enable mobile and handheld devices having fatigable storage to enable a support for a non-volatile virtual memory backing store. The non-volatile virtual memory backing store can enable virtual memory pages to be swapped to non-volatile memory to reduce memory pressure within system physical memory. Swap-induced wear to the storage device is reduced by employing statistical analysis and a machine learning model to select the specific applications that will be eligible to be swapped to storage. Should memory management logic determine that memory should be freed to reduce memory pressure, the memory management logic can swap eligible applications to storage, rather than terminating those applications and discarding their memory pages. Should a swapped application be launched by a user, the application and associated memory can be restored to memory instead of re-starting the application from an initialized state. In one embodiment, execution state for the application can be retained, such that application execution can be resumed at to the state immediately prior to being swapped to storage. The execution state for the application can include a graphical interface state for the application, including partially entered text or other interface details.

Compressed virtual memory can be employed in addition to enabling intelligent application swapping. A compressed region of virtual memory can be enabled by the virtual memory system and mapped to an address region in volatile memory. Active virtual memory pages in uncompressed volatile memory may be compressed and copied out to the compressed region virtual memory instead of or as a prelude to swapping the memory space of the application to fatigable nonvolatile memory. In some implementations of compressed virtual memory, virtual memory pages are managed in a manner that is agnostic to the applications making use of the virtual memory. In such implementations, compressed memory for multiple applications may be stored in the same region of compressed memory. Additionally, the virtual memory pages for the various applications may be paged into and out of compressed virtual memory based on a usage pattern of the virtual memory pages, rather than the usage pattern of individual applications. However, embodiments described herein provide application centric compressed virtual memory that enables the entire memory space of a selected application to be compressed and compacted into a non-volatile memory backing store.

In one embodiment, swapping an application to non-volatile storage includes mapping the virtual memory addresses of the application to an address region in non-volatile memory, compressing any uncompressed application memory, and compacting compressed application memory before storing the application memory to the address region in virtual memory. A mapping for the virtual memory addresses for the application can be maintained such that when the application is subsequently resumed or reactivated, a virtual memory page fault can trigger the stored memory for the application to be uncompacted and restored to memory. Previously uncompressed regions of application can be decompressed during the restore.

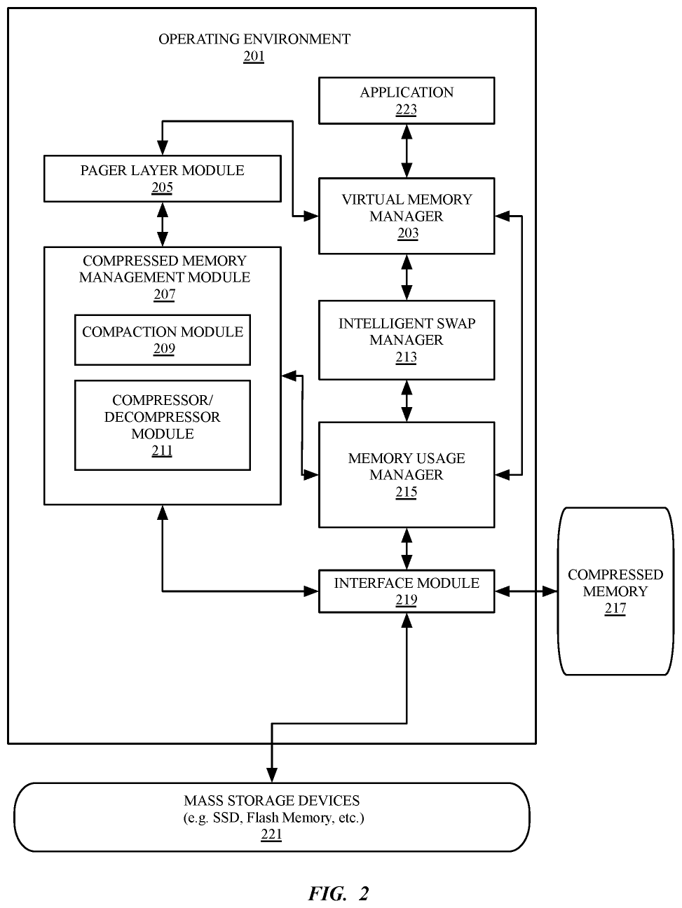

FIG. 2 is a block diagram illustrating a data processing system 200 including a compressed virtual memory system to enable compressed storage of application data to non-volatile virtual memory, according to an embodiment. In one embodiment, the data processing system 200 includes an operating environment 201 within a memory device of the data processing system 200. The operating environment 201 can be stored in a memory device such as the system memory device 122 as in FIG. 1 or any random-access memory (RAM) device that supports in-place execution of instructions. The data processing system 200 additionally includes one or more mass storage devices 221, which can include a solid-state drive (SSD), flash memory, or another form of electrically erasable non-volatile memory. The operating environment 201 can communicate with the mass storage devices 221 via an interface module 219, which can include a storage processor or memory controller that enables communication with the mass storage devices 221. The interface module 219 can also include a memory controller and program logic that enables communication with a region of compressed memory 217. The region of compressed memory 217 can reside in a different region of the memory storage device in which the operating environment 201 executes.

The operating environment 201 can include a virtual memory manager 203 in communication with an application 223 and a pager layer module 205. The application 223 can communicate with the virtual memory manager 203 to allocate and deallocate virtual memory. The pager layer module 205 can manage nonresident virtual memory pages in the backing store in non-volatile memory and fetch those pages when they are requested. In one embodiment, the pager layer module 205 can be configured to communicate with a compressed memory management module 207. The compressed memory management module 207 includes a compaction module 209 and a compressor/decompressor module 211. The compressed memory management module 207 can be configured to manage a pool of compressed memory 217 in the memory device. The pool of compressed memory 217 is, in one embodiment, an address region of the memory device that is configured to store compressed memory pages. The address region of the compressed memory pool can be mapped to an address region of virtual memory as a separate region from the uncompressed memory used for process execution.

In some embodiments, regions of compressed memory may be mapped or written to an address on the one or more mass storage devices 221, for example, to create additional space in compressed memory 217. In one embodiment, the compressed memory 217 includes arrays of compressed memory units, which may be variable sized compressed memory units. Each compressed memory unit can correspond to one or more virtual memory pages in uncompressed memory. Multiple variable sized compressed memory units in the compressed memory 217 can be compacted by the compaction module 209 into one or more fixed sized compacted memory segments. The compacted memory segments can include, for example, compressed data elements (e.g., compressed virtual memory pages) associated with the application 223. In one embodiment, the compacted memory segments are sized to facilitate efficient I/O transfer within or between memory devices on the data processing device, such as the memory device hosting the operating environment 201 and the one or more mass storage devices 221. Exemplary compacted memory segment sizes include 128 or 256 kilobytes. However, the specific size of the compacted memory segments can vary based on the I/O configuration of the data processing system.

In one embodiment, the operating environment 201 includes a memory usage management module 215 to manage memory usage of the operating environment 201. The memory usage management module 215 can perform various operations to increase the amount of physical memory available to executing applications based on the current state of system memory usage. The various operations can include terminating applications to reclaim memory space and, according to embodiments described herein, swap applications and application memory to the mass storage devices 221. In one embodiment, when an application is swapped to a mass storage device, the virtual memory of the application is flagged as protected so that the addresses are not released by the virtual memory system, although the physical memory used by the application can be re-assigned for other purposes.

In one embodiment the memory usage manager 215 adheres to a swap budget that limits the number of swaps that can occur within a given period of time. To optimize usage of the limited number of swaps, the memory usage manager 215 can communicate with an intelligent swap manager 213 to receive a vector that provides prediction data to indicate which of a set of active applications would make efficient use of swap space if swapped to the mass storage devices 221. Swap efficiency can be determined based on a variety of algorithms, including application popularity based on application usage time or number of application launches within a period of time. Swap efficiency can also be influenced by user routines that indicate regular and periodic usage of certain application. The intelligent swap manager 213 can provide a swap prediction vector to the memory usage manager 215. The memory usage manager 215 can use the swap prediction vector to inform decision making logic that determines whether an application and its associated memory should be swapped to non-volatile memory. Not all applications may be eligible to be swapped to memory at any given time, and the memory usage manager 215 may determine that, to preserve the long-term viability of the mass storage devices 221, an application will be terminated instead of being swapped. Alternatively, other techniques can be used to increase the amount of available memory in the system, such as compressing application memory into compressed memory 217 to free uncompressed memory for use, or to swap an application in compressed memory 217 to the mass storage device 221 to free space within the compressed memory 217.

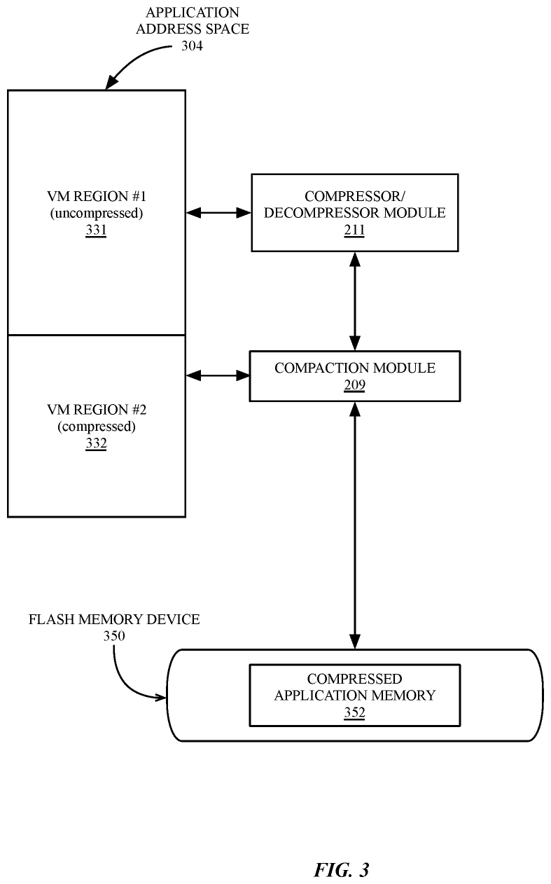

FIG. 3 is a block diagram illustrating swapping an application address space 304 to a flash memory device 350, according to an embodiment. A flash memory device 350 is illustrated, although the concepts described herein apply to any fatigable electrically erasable semiconductor memory. In one embodiment, an application (e.g., application 223 of FIG. 2) has an application address space 304 including a first virtual memory (VM) region 331 stored in uncompressed memory and a second VM region 332 stored in compressed memory. A memory usage manager (e.g., memory usage manager 215 of FIG. 2) can determine that an application should be swapped to the flash memory device 350. In one embodiment, when an application is swapped, the application address space 304 is stored to non-volatile storage. The first VM region 331 can be compressed by the compressor/decompressor module 211. The compressed memory can then be compacted by the compaction module 209. Any application memory in the second VM region 332 can be compacted by the compaction module 209. Compressed and compacted memory from the application address space 304 can be stored to compressed application memory 352 on the flash memory device 350.

In one embodiment, the compressed virtual memory of the second VM region 332 includes variable sized compressed data elements that are packed into fixed sized compacted memory segments by the compaction module 209. Additionally, the uncompressed virtual memory pages stored in the first VM region 331 can be compressed into compressed virtual memory pages by the compressor/decompressor module 211. The newly compressed virtual memory pages can be additionally compacted by the compaction module 209 into contiguous segments of compressed and compacted virtual memory (e.g., compacted virtual memory segments).

In one embodiment, a mapping between the virtual memory addresses associated with the application address space 304 can be made such that an access to virtual memory associated with the application can trigger a page fault, causing memory stored in the compressed application memory 352 to be loaded into memory. Compacted memory segments storing compressed data elements can be swapped back into the second VM region 332 in compressed form. Compacted memory segments storing compressed data elements that were uncompressed when the application was active can be swapped into the first VM region 331 in uncompressed form via the compressor/decompressor module 211.

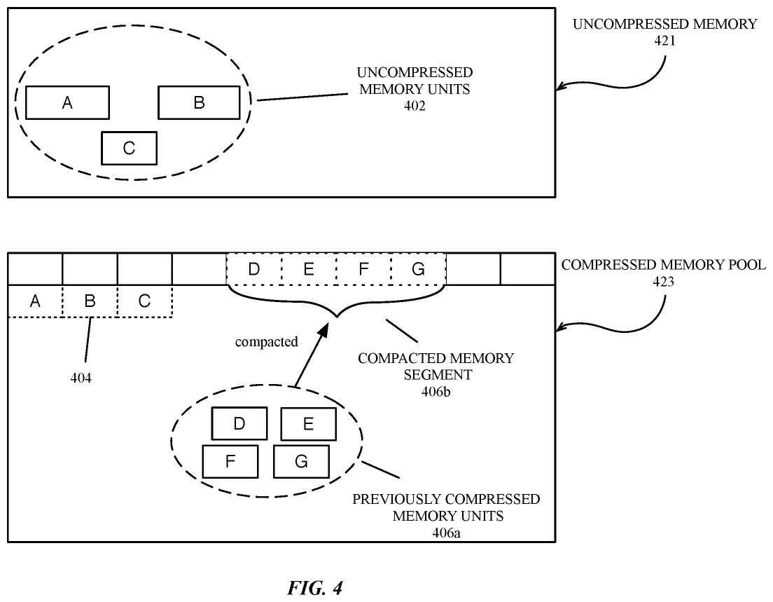

FIG. 4 is a block diagram illustrating compression and compaction of virtual memory, according to an embodiment. In one embodiment, process memory associated with an application includes uncompressed memory units 402, such as uncompressed virtual memory pages (e.g., page A; page B; page C) within a region of uncompressed memory 421. The memory pages may be contiguous or non-contiguous and may be of varying sizes. The virtual memory associated with the executing application can also include one or more previously compressed memory units 406a in a compressed memory pool 423. The previously compressed memory units 406a include compressed data elements such as one or more virtual memory pages (e.g., page D; page E; page F; page G) that have been previously compressed by a compression module (e.g., compressor/decompressor module 211 of FIGS. 2-3).

The previously compressed memory units 406a may be in disjoint locations within the compressed memory pool 423 until, in one embodiment, the previously compressed memory units 406 are gathered and compacted by a compaction module (e.g., compaction module 209 of FIGS. 2-3). The compaction module can compact the previously compressed memory units 406a (e.g., pages D-G) into one or more fixed size compacted memory segments 406b. In one embodiment, the previously compressed memory units 406a can be compacted without decompressing or recompressing any pages of the previously compressed memory.

In such embodiment, the uncompressed memory units 402 (e.g., pages A-C) associated with the application can also be compressed by a compressor/decompressor module and compacted into one or more fixed size compacted memory segments 404 in the compressed memory pool 423. In one embodiment, the compacted memory segments are sized to facilitate efficient I/O transfer within or between memory devices (e.g., within or between the system memory device 122 and the storage sub-system 130 of FIG. 1) during swap operations.

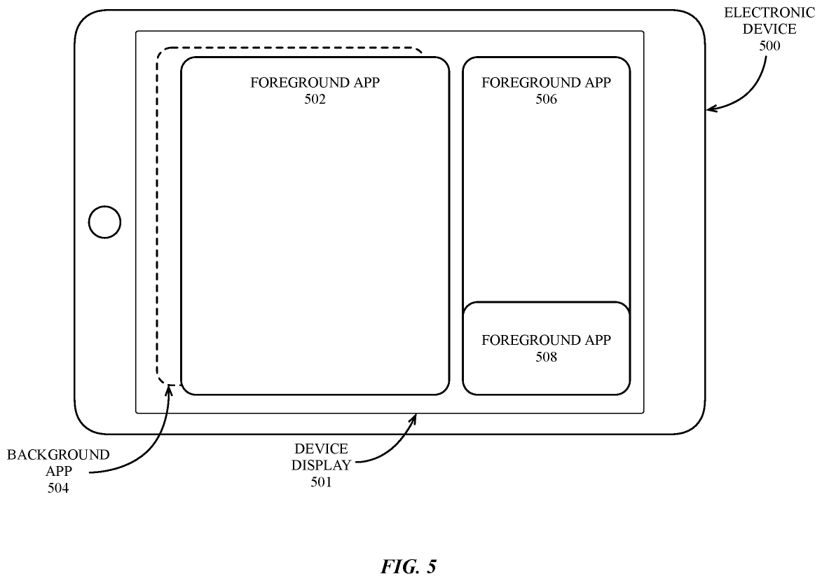

FIG. 5 is an illustration of an electronic device 500 with support for simultaneous execution of multiple applications, according to an embodiment. The electronic device 500, as illustrated, is a tablet computing device, although embodiments described herein are applicable to other types of electronic devices such as smartphone devices, laptop computers, desktop computers, or other computing devices described herein. The electronic device 500 includes a display device 501 on which multiple applications can be displayed. The applications include at least one background application 504 and one or more foreground applications (e.g., foreground application 502, foreground application 506, foreground application 508). Each foreground application can be one or more processes or threads executed by the electronic device 500.

The electronic device 500 includes a finite amount of physical memory that can be used to execute applications. When an application is launched, one or more processes are started for the application, with each application consuming a portion of available memory. The memory manager for the system can dynamically allocate portions of memory to the applications and free memory for reuse when no longer needed. As performing memory allocations becomes more difficult, the memory pressure of the system increases. At a series of memory pressure thresholds, memory pressure events occur. A memory pressure event occurs, for example, when the percentage of free memory available to the applications and other system resources falls below a threshold level, causing a memory page reclamation process to begin.

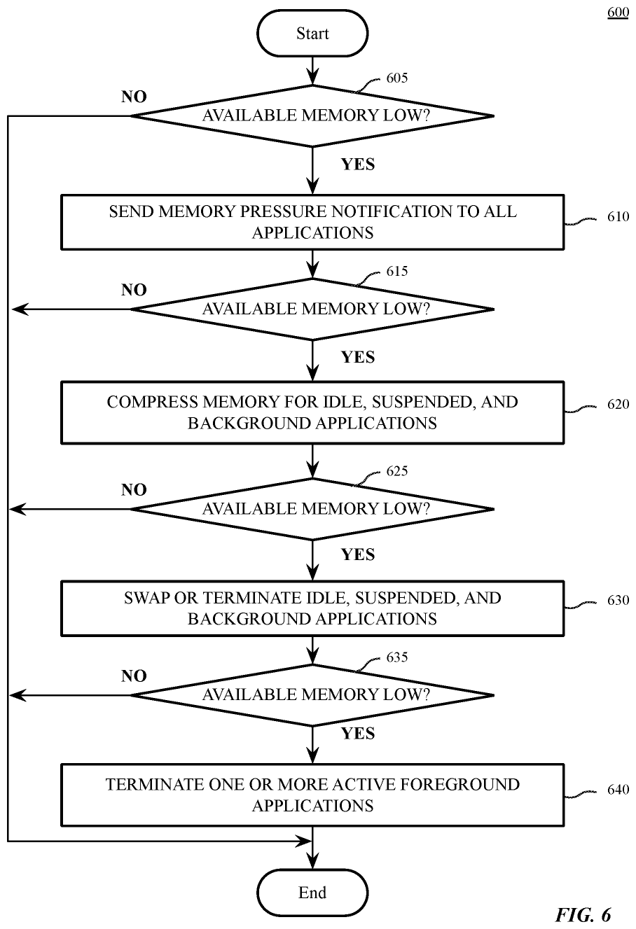

FIG. 6 is a flow diagram of logic 600 for a memory usage manager, according to an embodiment. The memory usage manager (e.g., memory usage manager 215) can work in conjunction with a virtual memory manager (e.g., virtual memory manager 203) to reclaim memory.

In one embodiment, the logic 600 includes to determine whether the available physical memory on the device is low, as shown at block 605. In one embodiment, the ratio of available physical memory to total physical memory on the device is used to determine whether the available physical memory is low. If the available physical memory is low, logic 600 can send memory pressure notifications to all applications, as shown at block 610. The notified applications may preemptively free up certain memory using application specific methods.

If the available memory is still low, as determined at block 615, logic 600 can compress memory for idle, suspended, and/or background applications, as shown at block 620. Idle, suspended, or background applications can have their application process space compressed into a compressed memory pool. If the application is re-activated, the application memory can be decompressed and restored.

If the available memory is still low, as determined at block 625, logic 600 can swap or terminate idle, suspended, and/or background applications, as shown at block 630. Idle, suspended, or background applications that have been compressed into the compressed memory pool can be swapped to non-volatile storage. Idle applications in uncompressed memory can be compressed and compacted before being stored to non-volatile memory. Alternatively, the application can be terminated, and the allocated memory of the application can be reclaimed. Swapping or terminating idle, suspended, and background applications is performed at block 630 to avoid the need to terminate one or more active foreground applications at block 640 if logic 600 determines at block 635 that the available memory remains low. The determination of whether to swap or terminate an application can be made based on a variety of factors. In one embodiment, the intelligent swap manager 213 described herein can generate an application swap probability calculation to determine a set of applications that would make the best use of a limited swap budget available. The probabilities can be feed to a machine learning model which can train based on calculated probabilities and historical application usage patterns. The machine learning model can then be used to generate a swap prediction vector that can be provided to the memory usage manager. The memory usage manager can use the provided information, along with other factors, to determine which applications can be swapped to non-volatile storage to relieve system memory pressure.

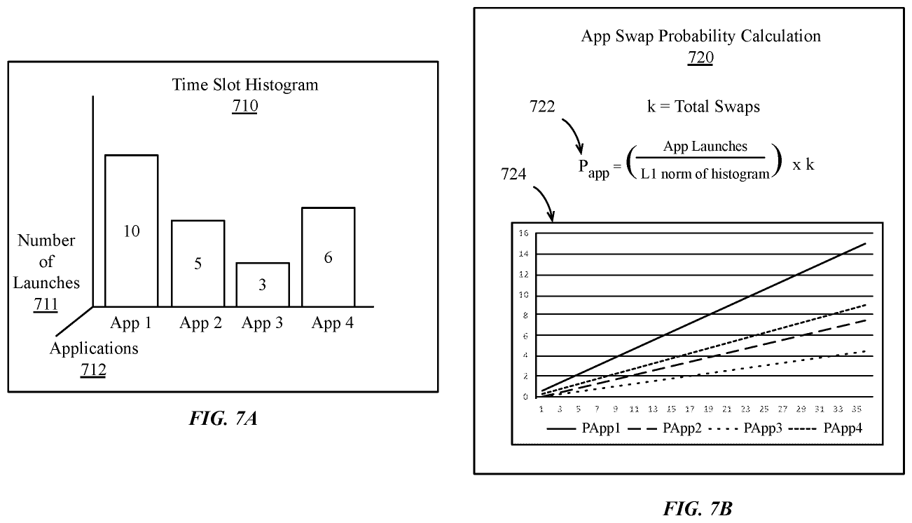

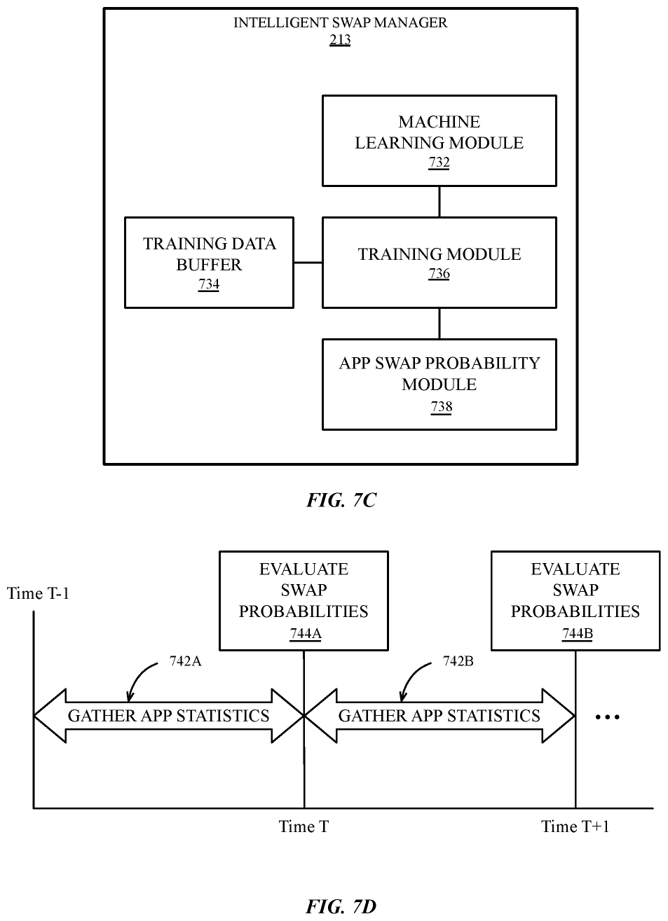

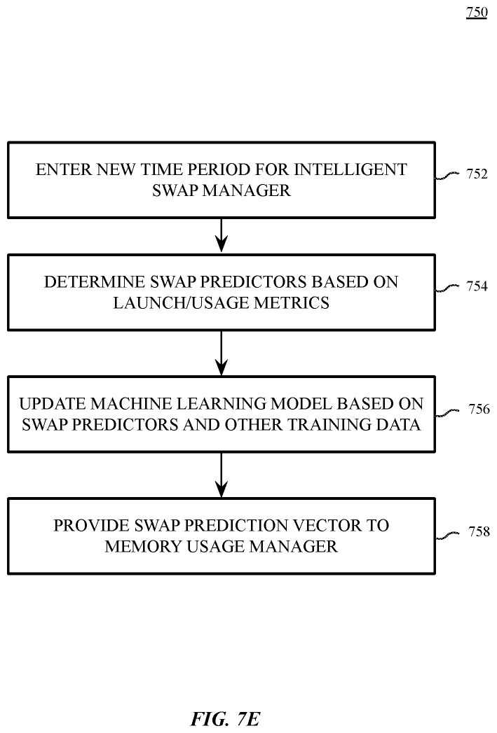

FIG. 7A-7E illustrate time-slot based application swap probability calculation, according to embodiments. Time-slot based application swap probability calculation is performed in some embodiments to allow re-calculating of app swap probabilities across multiple time slots during a given time period.

As shown in FIG. 7A, in one embodiment intelligent swap logic can generate a time slot histogram 710 for a given period of time. In one embodiment the time slot histogram 710 can indicate an application popularity metric, such as the number of launches 711 for a set of applications 712 during the period of time. The number of launches 711 can include a number of times an application is launched by selecting the application launch icon on the user interface of the computing device. The number of launches 711 can also include the number of times an application is selecting using a multitasking feature of the computing device. For example, if a user were to launch each of Application 1, Application 2, Application 3, and Application 4 during a time slot, one launch would be indicated for each application. In one embodiment, should a user switch from Application 2 to Application 1, the switch can be counted as an additional launch of Application 1. Should the user switch back to Application 2, that switch can be counted as an additional launch of Application 2. A new time slot histogram 710 can be generated for each time slot during a day. The number of time slots within a given day can be fixed to cover a specific time period per time slot. In one embodiment, the number of time slots within a given day can vary based on the usage of the application device. In some embodiments, alternate application popularity metrics can be used, such as a time in which an application is front-most and/or active on the computing device. In one embodiment, an overall application popularity metric can be generated based on application launches and front-most/active time for an application. In one embodiment, usage metrics can also be extended to specific processes or services on the computing device.

As shown in FIG. 7B, an application swap probability calculation 720 can be performed using one or more equations. The application swap probability calculation 720 can be used to determine a likelihood Pₐₚₚ 722 that an application will be re-launched within a period of time after the application is swapped. If an application is swapped to a background state, the system may experience a memory pressure event that can result in the termination of an application, for example, the termination of a background application at block 630 of FIG. 6. User experience is improved if the background application memory and execution state is swapped to non-volatile memory before the application is terminated, as execution of the application can be immediately resumed by restoring the application memory and execution state. Otherwise, the user may be required to re-launch the application from an initialized state.

In one embodiment Pₐₚₚ 722 can be calculated based on equation (1) below.

$${P}_{app} = ( \frac{App Launches}{{L}_{1} norm of histogram} ) \times k \qquad ( 1 )$$

Where k is the swap budget, which is the total number of swaps that can be performed within a period of time. The L₁ of the histogram can be calculated as shown in equation (2) below.

∥x∥₁=Σᵢ₌₁ⁿ|xᵢ|(2)

Pₐₚₚ 722 can be used to predict a likelihood 724 that, for a given swap budget k, a given application is likely to be re-launched after being swapped to non-volatile storage.

As shown in FIG. 7C, in one embodiment the intelligent swap manager 213 includes a machine learning model 732, a training data buffer 734, a training module 736, and an application swap probability module 738. The machine learning module 732 can include a machine learning model that is periodically re-trained by the training module 736 using data within a training data buffer 734. The training data buffer 734 can include historical application activity and memory usage patterns, as well as probabilities generated by the app swap probability module 738. The data in the training data buffer 734 can be used to refine the machine learning module 732 to enable the machine learning module 732 to better predict when applications are likely to be launched or re-launched within a given time period.

As shown in FIG. 7D, the intelligent swap manager 213 can gather application statistics (742A) during a first time period between time T−1 and time T, where T represents the duration of an evaluation period. At the end of an evaluation period, the intelligent swap manager 213 can perform operations to evaluate swap probabilities (744A) using the app swap probability module 738. After time T, the intelligent swap manager 213 can gather further application statistics (742B) before re-evaluating swap probabilities (744B) once more at time T+1. In one embodiment, the gathering of application usage statistics is performed only of the user of the system opts-in to the gathering of such statistics.

In one embodiment the intelligent swap manager 213 can implement logic 750 shown in FIG. 7E. Logic 750 can cause the intelligent swap manager 213 can enter a new time period for intelligent swap management, as shown at block 752. The length of the time period can vary across embodiments and implementations. The intelligent swap manager 213, via the app swap probability module 738, can determine swap predictors based on launch and/or usage metrics for applications executing on an electronic device, as shown at block 754. The specific launch and/or usage metrics that are used can vary based on the degree of statistics gathering for which the user of the system has provided consent. The intelligent swap manager 213 can then update a machine learning model based on swap predictors and other training data, as shown at block 756. The other training data can include other information that can be used to determine the best set of applications to swap to storage, including feedback provided by the memory usage manager 215. Using logic 750, the intelligent swap manager can then provide a swap prediction vector to the memory usage manager, as shown at block 758.

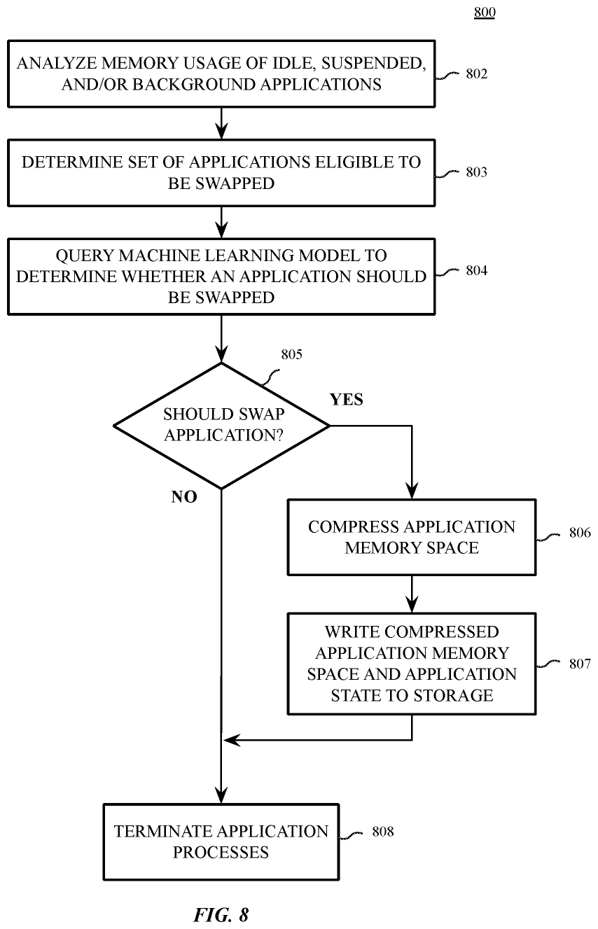

FIG. 8 is a flow diagram illustrating logic 800 for an intelligent swap determination by a memory usage manager, according to an embodiment. In one embodiment, logic 800 can be implemented by a memory usage manager 215 as in FIG. 2. For example, the memory usage manager 215 can determine that, based on memory pressure within the system, the memory usage manager 215 should swap or terminate idle, suspended, and/or background applications. The memory usage manager 215 can swap applications that are determined to be efficient use of a limited swap budget and terminate other applications that are not efficient to swap.

As shown at block 802 the memory usage manager 215 can use logic 800 to analyze memory usage of idle, suspended, and/or background applications. Logic 800 can then determine a set of applications that are eligible to be swapped, as shown at block 803. The set of applications that are eligible to be swapped can be determined using a variety of techniques. For example, in one embodiment the memory usage manager 215 can analyze the memory usage pattern for each of the idle, suspended, and/or background applications. The memory usage manager 215 can then determine, for example, the ratio of private to shared memory used by the application. An application that is using a large amount of shared memory may not be a good candidate to swap, as other applications or processes may be using that memory. If the application is swapped to non-volatile storage, shared memory of the application, if accessed by another process, which have to be restored to memory. Restoring the shared memory can negate any reduction in memory pressure caused by swapping the application. However, an application that is largely using private memory is potentially a good candidate to be swapped, as the private memory is only used by one application. Memory pressure reductions caused by swapping the application and the memory space of the application are likely to persist until the application is restored to memory. Additional factors can be considered to determine if an application can be added to the set of applications that are eligible to be swapped. For example, if the system is using a swap file to store applications that are swapped to non-volatile memory, the memory usage manager 215 can determine if sufficient swap file space exist to store the memory and execution state of the application. Where application memory is compressed before swap by transitioning application memory through a compressed region of virtual memory, sufficient space should be present in the compressor pool to compress the application memory space.

In one embodiment, if an application is added to the set of applications eligible to be swapped, the memory usage manager 215 will not swap the application unless the application is likely to be used again within a period of time. The likelihood of re-use can be determined by the intelligent swap manager 213 and the machine learning model associated with the intelligent swap manager 213. In one embodiment, logic 800 causes the memory usage manager 215 to query a machine learning model to determine whether an application should be swapped, as shown at block 804. In one embodiment the logic 800 causes the memory usage manager 215 to query the machine learning model for each application in the set of applications that are eligible to be swapped. In one embodiment, the intelligent swap manager 213 provides a swap prediction vector to the memory usage manager 215 that includes a probability value for each active application that indicates the likelihood of re-use for a swapped application. In one embodiment, the values of the swap prediction vector take into account whether an application is likely to be re-used as an active or front-most application, or if the application is likely to be launched as a background application.

At block 805, logic 800 can use a variety of metrics, including the machine learning model queries or swap prediction vector data to determine whether a given application should be swapped to fatigable non-volatile memory. If the application is not to be swapped, logic 800 of the memory usage manager 215 can simply terminate the one or more processes of the application 808 and reclaim the physical memory used by the application. If at block 805, logic 800 determines an application should be swapped, the memory usage manager 215 can direct paging logic (e.g., pager layer module 205 of FIG. 2) of the virtual memory system to swap the application address space and execution state to the fatigable non-volatile memory. As shown at block 806, where memory compression is in place, logic 800 can compress the application memory space, for example, via a compressor/decompressor module 211. In one embodiment, compressed memory can be compacted, for example, via a compaction module 209. Logic 800 can then write the compressed (and optionally compacted) application memory space and application state, including application execution state, to the fatigable non-volatile storage device. Logic 800 can then terminate the one or more application processes, as shown at block 808. However, while the application processes have been terminated, an attempt by the user to re-launch or re-activate the application can cause the application memory to be restored and the application can resume execution using the saved application state. However, if the application is not re-launched within a threshold period of time, the stored memory and application state may be discarded. The threshold period of time can vary, for example, based on the swap budget, the size of the stored memory, and the available storage space.

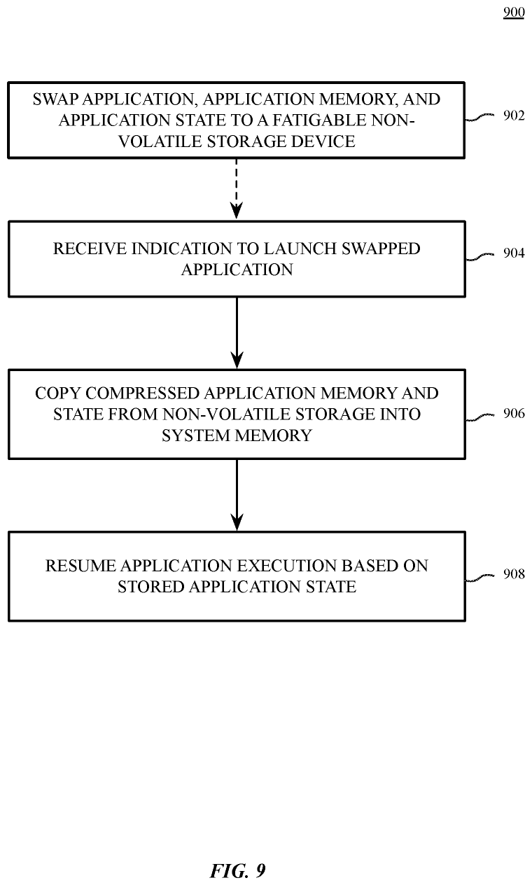

FIG. 9 illustrates a block diagram of a process 900 to swap and restore an application, according to an embodiment. The process 900 can be performed by a pager layer module 205 as in FIG. 2. As shown at block 902, the process 900 includes to swap an application, application memory, and application state to a fatigable non-volatile storage device, such a NAND flash device. Swapping the application, application memory, and application state can be performed using the swap processes and logic described herein.

As shown at block 904, after some period of time an application launcher can receive an indication to launch the swapped application. Upon receipt of such indication, the process 900 includes to copy compressed application memory and state from non-volatile storage to system memory, as shown at block 906. The process 900 additionally includes to resume execution of the application based on the stored application state, as shown at block 908.

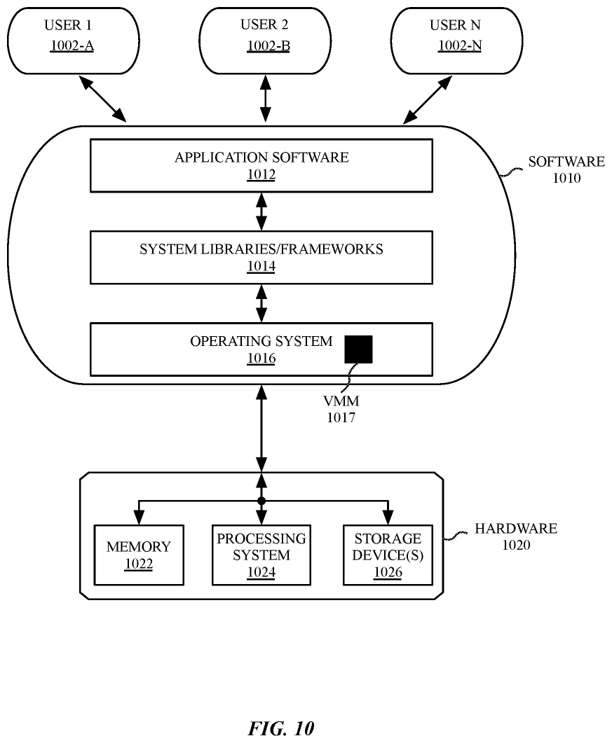

FIG. 10 is a block diagram of system architecture for a multi-user data processing system, according to an embodiment. The data processing system includes various software 1010 and hardware 1020 components configured to support multi-user data processing for 1 to N user accounts (e.g., User 1 1002-A, User 2 1002-B, User N 1002-N). In one embodiment, software 1010 of the system can be used to implement a variant of the operating environment 201 of FIG. 2. The hardware 1020 can be configured with components to provide a virtual memory system, such as the virtual memory system shown in FIG. 1. Processes associated with each user account can access application software 1012 through a user interface provided by an operating system (OS) 1016. The hardware 1020 of the data processing system can include one or more memory devices 1022, a processing system 1024 including one or more processors, and one or more storage devices 1026.

A virtual memory manager VMM 1017 can provide memory management services, such as virtual memory mapping and paging. The operating system 1016 can configure the VMM 1017 to map addresses on the storage devices 1026 into memory, for example, to load binary objects for application software 1012 or system libraries or frameworks 1014, or to store or load compressed and compacted memory to or from a fatigable non-volatile storage device, according to embodiments described herein.

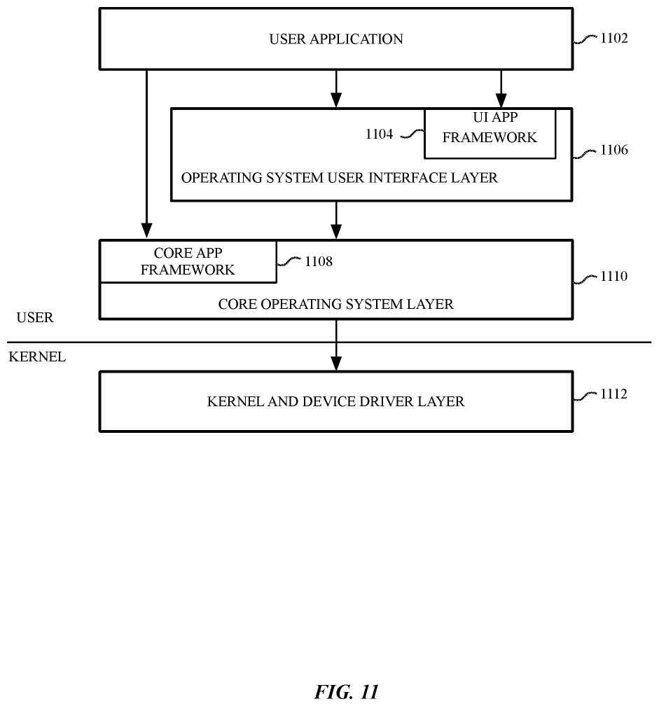

FIG. 11 is a block diagram of a multi-layer software architecture used by a data processing system, according to an embodiment. The software components are illustrated with a division between user space and a kernel space. Although other arrangements are possible, user applications (e.g., user application 1102), and some operating system components (e.g., operating system user interface layer 1106, and the core operating system layer 1110) execute in user space. In kernel space, the operating system kernel and a set of device drivers operate in the kernel and device driver layer 1112. The kernel and device driver layer 1112 manage the underlying functionality of the overall operating system and provide a formalized and secure mechanism for user space software to access data processing system hardware.

A user interface (UI) application framework 1104 provides a mechanism for the user application 1102 to access UI services provided by the operating system (OS) UI layer 1106. Underlying operating system functions that are not related to the user interface are performed in the core operating system layer 1110. One or more data management frameworks, such as a core app framework 1108 can be made available to a user application to facilitate access to operating system functions.

The exemplary user application 1102 may be any one of a plurality of user applications, such as a web browser, a document viewer, a picture viewer, a movie player, a word processing or text editing application, an email application, or other applications known in the art. The user application 1102 accesses instructions in an exemplary UI app framework 1104 for creating and drawing graphical user interface objects such as icons, buttons, windows, dialogs, controls, menus, and other user interface elements. The UI application framework 1104 also provides additional functionality including menu management, window management, and document management, as well as file open and save dialogs, drag-and-drop, and copy-and-paste handling.

The core operating system layer 1110 contains operating system components that implement features including and related to application security, system configuration, graphics and media hardware acceleration, and directory services. Multiple application frameworks, including the core app framework 1108, provide a set of APIs to enable a user application 1102 to access core services that are essential to the application, but are not directly related to the user interface of the application. The core app framework 1108 can facilitate an application's access to database services, credential and security services, backup services, data synchronization services, and other underlying functionality that may be useful to an application.

The core app framework 1108, or equivalent application frameworks, can provide access to remote server-based storage for functionality including synchronized document storage, key-value storage, and database services. Key-value storage allows a user application 1102 to share small amounts of data such as user preferences or bookmarks among multiple instances of the user application 1102 across multiple client devices. The user application 1102 can also access server-based, multi-device database solutions via the core app framework 1108.

The systems and methods described herein can be implemented in a variety of different data processing systems and devices, including general-purpose computer systems, special purpose computer systems, or a hybrid of general purpose and special purpose computer systems. Exemplary data processing systems that can use any one of the methods described herein include desktop computers, laptop computers, tablet computers, smart phones, cellular telephones, personal digital assistants (PDAs), embedded electronic devices, or consumer electronic devices.

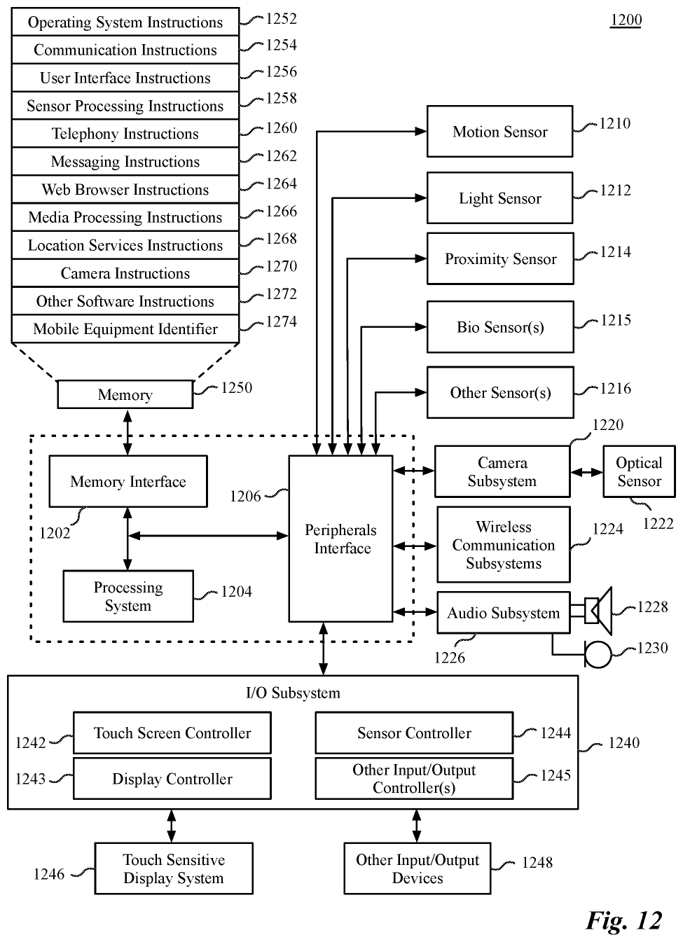

FIG. 12 is a block diagram of a device architecture 1200 for a mobile or embedded device, according to an embodiment. The device architecture 1200 includes a memory interface 1202, a processing system 1204 including one or more data processors, image processors and/or graphics processing units, and a peripherals interface 1206. The various components can be coupled by one or more communication buses or signal lines. The various components can be separate logical components or devices or can be integrated in one or more integrated circuits, such as in a system on a chip integrated circuit.

The memory interface 1202 can be coupled to memory 1250, which can include high-speed random-access memory such as static random-access memory (SRAM) or dynamic random-access memory (DRAM) and/or non-volatile memory, such as but not limited to flash memory (e.g., NAND flash, NOR flash, etc.).

Sensors, devices, and subsystems can be coupled to the peripherals interface 1206 to facilitate multiple functionalities. For example, a motion sensor 1210, a light sensor 1212, and a proximity sensor 1214 can be coupled to the peripherals interface 1206 to facilitate the mobile device functionality. One or more biometric sensor(s) 1215 may also be present, such as a fingerprint scanner for fingerprint recognition or an image sensor for facial recognition. Other sensors 1216 can also be connected to the peripherals interface 1206, such as a positioning system (e.g., GPS receiver), a temperature sensor, or other sensing device, to facilitate related functionalities. A camera subsystem 1220 and an optical sensor 1222, e.g., a charged coupled device (CCD) or a complementary metal-oxide semiconductor (CMOS) optical sensor, can be utilized to facilitate camera functions, such as recording photographs and video clips.

Communication functions can be facilitated through one or more wireless communication subsystems 1224, which can include radio frequency receivers and transmitters and/or optical (e.g., infrared) receivers and transmitters. The specific design and implementation of the wireless communication subsystems 1224 can depend on the communication network(s) over which a mobile device is intended to operate. For example, a mobile device including the illustrated device architecture 1200 can include wireless communication subsystems 1224 designed to operate over a GSM network, a CDMA network, an LTE network, a Wi-Fi network, a Bluetooth network, or any other wireless network. In particular, the wireless communication subsystems 1224 can provide a communications mechanism over which a media playback application can retrieve resources from a remote media server or scheduled events from a remote calendar or event server.

An audio subsystem 1226 can be coupled to a speaker 1228 and a microphone 1230 to facilitate voice-enabled functions, such as voice recognition, voice replication, digital recording, and telephony functions. In smart media devices described herein, the audio subsystem 1226 can be a high-quality audio system including support for virtual surround sound.

The I/O subsystem 1240 can include a touch screen controller 1242 and/or other input controller(s) 1245. For computing devices including a display device, the touch screen controller 1242 can be coupled to a touch sensitive display system 1246 (e.g., touch-screen). The touch sensitive display system 1246 and touch screen controller 1242 can, for example, detect contact and movement and/or pressure using any of a plurality of touch and pressure sensing technologies, including but not limited to capacitive, resistive, infrared, and surface acoustic wave technologies, as well as other proximity sensor arrays or other elements for determining one or more points of contact with a touch sensitive display system 1246. Display output for the touch sensitive display system 1246 can be generated by a display controller 1243. In one embodiment, the display controller 1243 can provide frame data to the touch sensitive display system 1246 at a variable frame rate.

In one embodiment, a sensor controller 1244 is included to monitor, control, and/or processes data received from one or more of the motion sensor 1210, light sensor 1212, proximity sensor 1214, or other sensors 1216. The sensor controller 1244 can include logic to interpret sensor data to determine the occurrence of one of more motion events or activities by analysis of the sensor data from the sensors.

In one embodiment, the I/O subsystem 1240 includes other input controller(s) 1245 that can be coupled to other input/control devices 1248, such as one or more buttons, rocker switches, thumb-wheel, infrared port, USB port, and/or a pointer device such as a stylus, or control devices such as an up/down button for volume control of the speaker 1228 and/or the microphone 1230.

In one embodiment, the memory 1250 coupled to the memory interface 1202 can store instructions for an operating system 1252, including portable operating system interface (POSIX) compliant and non-compliant operating system or an embedded operating system. The operating system 1252 may include instructions for handling basic system services and for performing hardware dependent tasks. In some implementations, the operating system 1252 can be a kernel.

The memory 1250 can also store communication instructions 1254 to facilitate communicating with one or more additional devices, one or more computers and/or one or more servers, for example, to retrieve web resources from remote web servers. The memory 1250 can also include user interface instructions 1256, including graphical user interface instructions to facilitate graphic user interface processing.

Additionally, the memory 1250 can store sensor processing instructions 1258 to facilitate sensor-related processing and functions; telephony instructions 1260 to facilitate telephone-related processes and functions; messaging instructions 1262 to facilitate electronic-messaging related processes and functions; web browser instructions 1264 to facilitate web browsing-related processes and functions; media processing instructions 1266 to facilitate media processing-related processes and functions; location services instructions including GPS and/or navigation instructions 1268 and Wi-Fi based location instructions to facilitate location based functionality; camera instructions 1270 to facilitate camera-related processes and functions; and/or other software instructions 1272 to facilitate other processes and functions, e.g., security processes and functions, and processes and functions related to the systems. The memory 1250 may also store other software instructions such as web video instructions to facilitate web video-related processes and functions; and/or web shopping instructions to facilitate web shopping-related processes and functions. In some implementations, the media processing instructions 1266 are divided into audio processing instructions and video processing instructions to facilitate audio processing-related processes and functions and video processing-related processes and functions, respectively. A mobile equipment identifier, such as an International Mobile Equipment Identity (IMEI) 1274 or a similar hardware identifier can also be stored in memory 1250.

Each of the above identified instructions and applications can correspond to a set of instructions for performing one or more functions described above. These instructions need not be implemented as separate software programs, procedures, or modules. The memory 1250 can include additional instructions or fewer instructions. Furthermore, various functions may be implemented in hardware and/or in software, including in one or more signal processing and/or application specific integrated circuits.

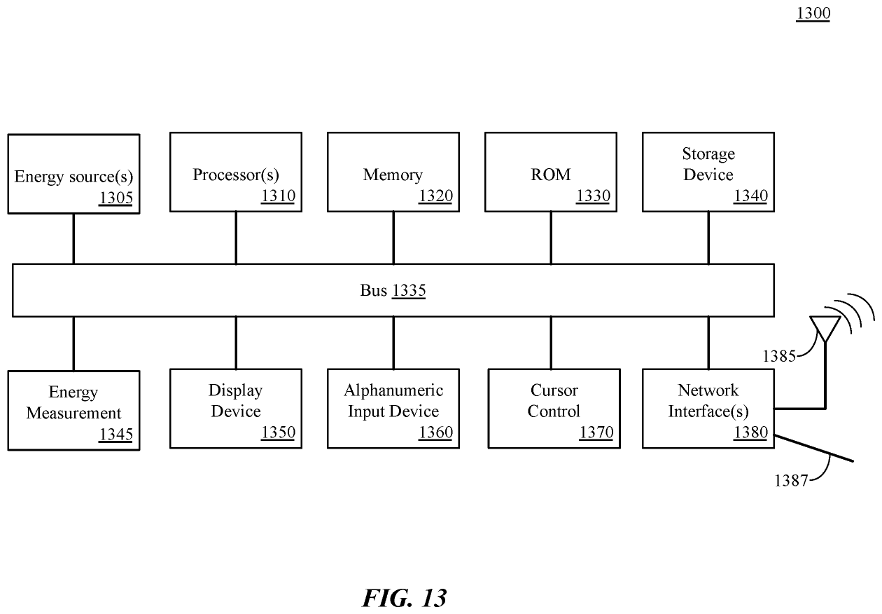

FIG. 13 is a block diagram of a computing system 1300, according to an embodiment. The illustrated computing system 1300 is intended to represent a range of computing systems (either wired or wireless) including, for example, desktop computer systems, laptop computer systems, tablet computer systems, cellular telephones, personal digital assistants (PDAs) including cellular-enabled PDAs, set top boxes, entertainment systems or other consumer electronic devices, smart appliance devices, or one or more implementations of a smart media playback device. Alternative computing systems may include more, fewer and/or different components. The computing system 1300 can be used to provide the computing device and/or a server device to which the computing device may connect.

The computing system 1300 includes bus 1335 or other communication device to communicate information, and processor(s) 1310 coupled to bus 1335 that may process information. While the computing system 1300 is illustrated with a single processor, the computing system 1300 may include multiple processors and/or co-processors. The computing system 1300 further may include memory 1320 such as random access memory (RAM) or other dynamic storage device coupled to the bus 1335. The memory 1320 may store information and instructions that may be executed by processor(s) 1310. The memory 1320 may also be used to store temporary variables or other intermediate information during execution of instructions by the processor(s) 1310.

The computing system 1300 may also include read only memory (ROM) 1330 and/or another data storage device 1340 coupled to the bus 1335 that may store information and instructions for the processor(s) 1310. The data storage device 1340 can be or include a variety of storage devices, such as a flash memory device, a magnetic disk, or an optical disc and may be coupled to computing system 1300 via the bus 1335 or via a remote peripheral interface.

The computing system 1300 may also be coupled, via the bus 1335, to a display device 1350 to display information to a user. The computing system 1300 can also include an alphanumeric input device 1360, including alphanumeric and other keys, which may be coupled to bus 1335 to communicate information and command selections to processor(s) 1310. Another type of user input device includes a cursor control 1370 device, such as a touchpad, a mouse, a trackball, or cursor direction keys to communicate direction information and command selections to processor(s) 1310 and to control cursor movement on the display device 1350. The computing system 1300 may also receive user input from a remote device that is communicatively coupled via one or more network interface(s) 1380.

The computing system 1300 further may include one or more network interface(s) 1380 to provide access to a network, such as a local area network. The network interface(s) 1380 may include, for example, a wireless network interface having antenna 1385, which may represent one or more antenna(e). The computing system 1300 can include multiple wireless network interfaces such as a combination of Wi-Fi, Bluetooth®, near field communication (NFC), and/or cellular telephony interfaces. The network interface(s) 1380 may also include, for example, a wired network interface to communicate with remote devices via network cable 1387, which may be, for example, an Ethernet cable, a coaxial cable, a fiber optic cable, a serial cable, or a parallel cable.

In one embodiment, the network interface(s) 1380 may provide access to a local area network, for example, by conforming to IEEE 802.11 standards, and/or the wireless network interface may provide access to a personal area network, for example, by conforming to Bluetooth standards. Other wireless network interfaces and/or protocols can also be supported. In addition to, or instead of, communication via wireless LAN standards, network interface(s) 1380 may provide wireless communications using, for example, Time Division, Multiple Access (TDMA) protocols, Global System for Mobile Communications (GSM) protocols, Code Division, Multiple Access (CDMA) protocols, Long Term Evolution (LTE) protocols, and/or any other type of wireless communications protocol.

The computing system 1300 can further include one or more energy sources 1305 and one or more energy measurement systems 1345. Energy sources 1305 can include an AC/DC adapter coupled to an external power source, one or more batteries, one or more charge storage devices, a USB charger, or other energy source. Energy measurement systems include at least one voltage or amperage measuring device that can measure energy consumed by the computing system 1300 during a predetermined period of time. Additionally, one or more energy measurement systems can be included that measure, e.g., energy consumed by a display device, cooling subsystem, Wi-Fi subsystem, or other frequently used or high-energy consumption subsystem.

As described above, one aspect of the present technology includes the gathering and use of application activity data to improve the performance of virtual memory systems that swap to fatigable storage devices. The present disclosure contemplates that in some instances, this gathered data may include personal information data that uniquely identifies or can be used to identify a specific person. Such personal information data can include demographic data, location-based data, online identifiers, telephone numbers, email addresses, home addresses, data or records relating to a user's health or level of fitness (e.g., vital signs measurements, medication information, exercise information), date of birth, or any other personal information. While this data may be gathered by a computing system described herein, the usage of such data will be local to the gathering computer system.

The present disclosure recognizes that the use of such personal information data, in the present technology, can be used to enhance the user experience for users of computing devices, particularly mobile computing devices. The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominent and easily accessible by users and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations that may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data, such as application usage data. Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data, as at least some application prediction and swap optimization can be performed without the use of personal information of a user.

In the foregoing description, example embodiments of the disclosure have been described. It will be evident that various modifications can be made thereto without departing from the broader spirit and scope of the disclosure. The specification and drawings are, accordingly, to be regarded in an illustrative sense rather than a restrictive sense. The specifics in the descriptions and examples provided may be used anywhere in one or more embodiments. The various features of the different embodiments or examples may be variously combined with some features included and others excluded to suit a variety of different applications. Examples may include subject matter such as a method, means for performing acts of the method, at least one machine-readable medium including instructions that, when performed by a machine cause the machine to perform acts of the method, or of an apparatus or system according to embodiments and examples described herein. Additionally, various components described herein can be a means for performing the operations or functions described herein.

Various embodiments and aspects of a virtual memory system for electronic devices in which swapping of virtual memory to non-volatile storage is enabled for fatigable storage devices such as NAND flash devices and/or other electrically erasable semiconductor memories. Wear to the storage devices is limited by the use of an intelligent swap manager that selects the most efficient applications to swap to non-volatile storage. The intelligent swap manager can gather application popularity statistics (launches, activations, etc.) during a time period and generate a set of probabilities that an application will be used within a given time period. Such probabilities can be used along with other device behavior data to generate a training set of a probability model. In one embodiment, the gathering of application usage statistics is performed only of the user of the system opts-in to the gathering of such statistics.

One embodiment provides for a method comprising determining a set of probabilities associated with a set of applications configured to execute on an electronic device, updating a probability model based on the set of probabilities associated with the set of applications, the set of probabilities including a probability of application usage, selecting an application to swap to a fatigable storage device based on output from the probability model, and swapping the application to the fatigable storage device, wherein swapping the application includes storing data within a memory address space for the application and an application state.

One embodiment provides for an electronic device comprising a non-volatile electrically-erasable semiconductor memory device, a memory device coupled with the non-volatile electrically-erasable semiconductor memory device, and one or more processors to load instructions from the non-volatile electrically-erasable semiconductor memory device into the memory device and execute the instructions. The instructions, when executed, cause the one or more processors to determine a set of probabilities associated with a set of applications configured to execute on the electronic device, the set of probabilities including a probability of application usage, update a probability model based on the set of probabilities, receive a request to terminate a process of an application in the set of applications, the application having a virtual address space at least partially mapped to the memory device, query the probability model to determine whether memory of the application is to be swapped to the non-volatile electrically-erasable semiconductor memory device before the process is to be terminated, and store memory within the virtual address space of the application to the non-volatile electrically-erasable semiconductor memory device based on a result of the query.

One embodiment provides for a non-transitory machine-readable medium storing instructions to cause one or more processors of an electronic device to perform operations comprising determining a set of probabilities associated with a set of applications configured to execute on the electronic device, updating a probability model based on the set of probabilities associated with the set of applications, the set of probabilities including a probability of application usage, selecting an application to swap to a fatigable storage device based on output from the probability model, wherein the probability model includes a machine-learning model, and swapping the application to the fatigable storage device, wherein swapping the application includes storing data within a memory address space for the application and an application state.

Besides what is described herein, various modifications can be made to the disclosed embodiments and implementations without departing from their scope. Therefore, the illustrations and examples herein should be construed in an illustrative, and not a restrictive sense. The scope and spirit of the various embodiments should be measured solely by reference to the claims that follow.

What is claimed is:

1. A method comprising:
determining a set of probabilities associated with a set of applications configured to execute on an electronic device;
updating a probability model based on the set of probabilities associated with the set of applications, the set of probabilities including a probability of application usage;
selecting an application to swap to a fatigable storage device based on output from the probability model; and
swapping the application to the fatigable storage device, wherein swapping the application includes storing data within a memory address space for the application and an application state.

2. The method as in claim 1, additionally comprising swapping the application to the fatigable storage device in response to a memory pressure event.

3. The method as in claim 1, wherein storing the memory address space for the application including compressing data within the memory address space for the application and storing the data to the fatigable storage device.

4. The method as in claim 1, wherein the fatigable storage device is an electrically erasable non-volatile semiconductor memory device.

5. The method as in claim 1, additionally comprising:
receiving a message to launch the application;
restoring stored data for the memory address space of the application from the fatigable storage device to memory;
reading the application state for the application from the fatigable storage device; and
launching the application based on the application state.

6. The method as in claim 5, wherein the application state includes an execution state for the application and launching the application based on the application state includes resuming execution of the application based on the execution state for the application.

7. The method as in claim 6, wherein the application state additionally includes user interface state for the application.

8. The method as in claim 1, wherein the probability model is a machine learning model.

9. An electronic device comprising:
a non-volatile electrically-erasable semiconductor memory device;
a memory device coupled with the non-volatile electrically-erasable semiconductor memory device;
one or more processors to load instructions from the non-volatile electrically-erasable semiconductor memory device into the memory device and execute the instructions, wherein the instructions, when executed, cause the one or more processors to:
determine a set of probabilities associated with a set of applications configured to execute on the electronic device, the set of probabilities including a probability of application usage;
update a probability model based on the set of probabilities;
receive a request to terminate a process of an application in the set of applications, the application having a virtual address space at least partially mapped to the memory device;
query the probability model to determine whether memory of the application is to be swapped to the non-volatile electrically-erasable semiconductor memory device before the process is to be terminated; and
store memory within the virtual address space of the application to the non-volatile electrically-erasable semiconductor memory device based on a result of the query.

10. The electronic device as in claim 9, wherein the probability model is a machine learning model.

11. The electronic device as in claim 9, the one or more processors additionally to terminate the process of the application, wherein the request to terminate the process of the application is issued in response to a memory pressure event.

12. The electronic device as in claim 9, wherein to swap memory within the virtual address space of the application includes to compress the memory and store the memory to the non-volatile electrically-erasable semiconductor memory device.

13. The electronic device as in claim 9, the one or more processors to additionally to store a process state for the process of the application to the non-volatile electrically-erasable semiconductor memory device, the process state including an execution state for the process of the application and a user interface state for the application.

14. The electronic device as in claim 13, the one or more processors additionally to:
receive a message to launch the application;
swap the memory within the virtual address space of the application from the non-volatile electrically-erasable semiconductor memory device to the memory device;
restore the process state for the process of the application;
resume execution of the application; and
restore the user interface state for the application.

15. The electronic device as in claim 9, the one or more processors additionally to delete stored memory for the application in response to a determination that the application has not been launched for threshold period of time.

16. A non-transitory machine-readable medium storing instructions to cause one or more processors of an electronic device to perform operations comprising:
determining a set of probabilities associated with a set of applications configured to execute on the electronic device;
updating a probability model based on the set of probabilities associated with the set of applications, the set of probabilities including a probability of application usage;
selecting an application to swap to a fatigable storage device based on output from the probability model, wherein the probability model includes a machine-learning model; and
swapping the application to the fatigable storage device, wherein swapping the application includes storing data within a memory address space for the application and an application state.

17. The non-transitory machine-readable medium as in claim 16, additionally comprising swapping the application to the fatigable storage device in response to a memory pressure event.

18. The non-transitory machine-readable medium as in claim 16, wherein storing the memory address space for the application including compressing data within the memory address space for the application and storing the data to the fatigable storage device.

19. The non-transitory machine-readable medium as in claim 16, wherein the fatigable storage device is an electrically erasable non-volatile semiconductor memory device.

20. The non-transitory machine-readable medium as in claim 16, additionally comprising:
receiving a message to launch the application;
restoring stored data for the memory address space of the application from the fatigable storage device to memory;
reading the application state for the application from the fatigable storage device; and
launching the application based on the application state, wherein the application state includes an execution state for the application, launching the application based on the application state includes resuming execution of the application based on the execution state for the application, the application state additionally includes user interface state for the application, and resuming execution of the application additionally includes restoring the user interface state for the application.
